(19) United States
(12) Patent Application Publication
(10) Pub. No.: US 2015/0320030 A1
(43) Pub. Date: Nov. 12, 2015

(54) BIRD REPELLING PLATFORM

(71) Applicants: Gordon Sabine, Santa Monica, CA (US); AREANNA SABINE, Santa Monica, CA (US)

(72) Inventors: Gordon Sabine, Santa Monica, CA (US); AREANNA SABINE, Santa Monica, CA (US)

(21) Appl. No.: 14/706,688

(22) Filed: May 7, 2015

Related U.S. Application Data
(60) Provisional application No. 61/989,532, filed on May 7, 2014.

(51) Int. Cl. A01M 29/32; E04B 1/72

(52) U.S. Cl. CPC A01M 29/32; E04B 1/72

(57) ABSTRACT

A bird repelling platform for placement in areas such airfield and transmission towers, or other locations where the landing of birds are unsafe or undesirable. A landing platform is rotatably secured to a fulcrum, which is in turn secured to a base configured to attach to a post. The landing platform may contain weight that causes the landing platform to tilt to one side where the opposite side of the landing platform serves as a perch for a bird to land. Even without weight, a bird landing on the landing platform would inevitably lose its balance and fly away. As birds tend to land at the highest position in its environment, the bird repelling platform can be placed on a high post disposed on an airfield or transmission tower, or on the highest point of the tower.

### CROSS-REFERENCE TO RELATED APPLICATION

This application claims priority to provisional patent application No. 61/989,532 filed on May 7, 2014.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention generally relates to bird repellent systems, in particular, a platform that repels birds that attempt to perch in an airfield or other undesirable locations. Birds often perch on poles, rods, cables, wires, antennas, and other high posts when looking for prey. A post can be any support or point of attachment, including but not limited to, airport runway directional signs, power pole cross arms and horizontal steel on transmission towers. When birds perch on an airfield, their flight pattern causes a dangerous situation for aerial vehicles attempting to land or depart from an airstrip. Birds often crash into planes, causing planes to crash or causing serious damage to the aircraft.

In addition, birds sometimes get electrocuted when they come in contact with power poles and transmission towers. This is problematic, especially for endangered bird species. By the same token, these high posts provide a platform for birds of prey that may threaten endangered species on the ground. High posts also provide an opportunity for birds to leave bird droppings in undesirable locations, which create safety and health problems. Therefore, there is a need to control the places where birds may perch.

The present invention seeks to address this challenge by creating a false landing platform for birds that is similar to a seesaw, having a platform balanced in the center so that when the weight of a bird is positioned on a first edge of the platform, the second edge immediately shifts up and the first edge shifts down, causing a prompt imbalance of the platform. This imbalance triggers an evolutionary instinct in the bird to fly away.

In one embodiment of the platform, weight is disposed on a first edge, so that the platform is positioned diagonally, with the first edge facing downwardly and a second edge facing upwardly. In a second embodiment, there is no weight, and the platform may be initially positioned horizontally. In both embodiments, when a bird lands on a first edge, or lands in the center and shifts its weight toward a first edge, the weight of the bird causes an imbalance in the platform so that it immediately shifts diagonally, and the bird instinctively flies away. If the bird flies back in an attempt to land on a second edge or at a different angle, the weight of the bird again causes the platform to shift diagonally so that the bird again instinctively flies away. An imbalanced perch is not desirable for birds due to the excess amount of energy necessary to be expended in order to attempt to find a balance point.

Birds instinctively land on a high post, which is where the inventive landing platform is to be disposed. When the bird is repelled from the landing platform, birds' flight patterns can no longer create a dangerous situation for themselves, aerial vehicles, and endangered ground species, or form bird droppings in undesirable locations.

The inventive landing platform may consist of more than one platform, as long as the platforms are balanced in the center. An example of this alternative design is a five point star, wherein a bird would land on an arm of a star, which causes the star to shift to a downwardly position, causing the bird to fall off. If the bird were to fly to another arm of the star, said arm would also shift downwardly.

### SUMMARY

A bird repelling platform that discourages birds from landing in dangerous areas such as airfields, power poles, transmission towers, and other undesirable locations. Birds have an evolutionary instinct to land on the highest position in an environment. A bird seeking to land in the dangerous area or undesirable location would attempt to land on the bird repelling platform placed on that post. The bird repelling platform has a landing platform disposed on a fulcrum which causes the landing platform to immediately tilt to one side when a bird lands on any part of the landing platform. The loss of balance or the instability of the landing platform causes the bird to fly away, or at least discourages the bird from trying to remain due to the loss of energy necessary to be exerted in order to maintain a balanced perch. The landing platform may have a weight attached to one side of the landing platform so that the other side forms a natural perch where a bird would land. The weight attached to one side of the landing platform is sufficient to cause the landing platform to tilt, but is lighter than the weight of the target bird expected to land on the perch. The target bird's heavier weight would cause the landing platform to tilt on the side of the bird, causing the bird to fall off or lose balance, thereby causing the bird to fly away.

The present invention would be better understood with reference to the attached figures.

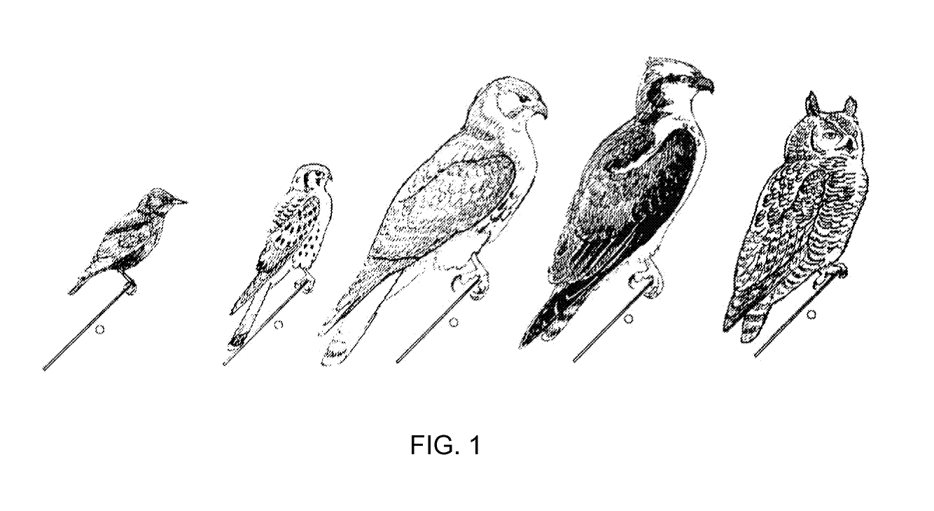

FIG. 1 illustrates the manner in which a bird perches on the invention

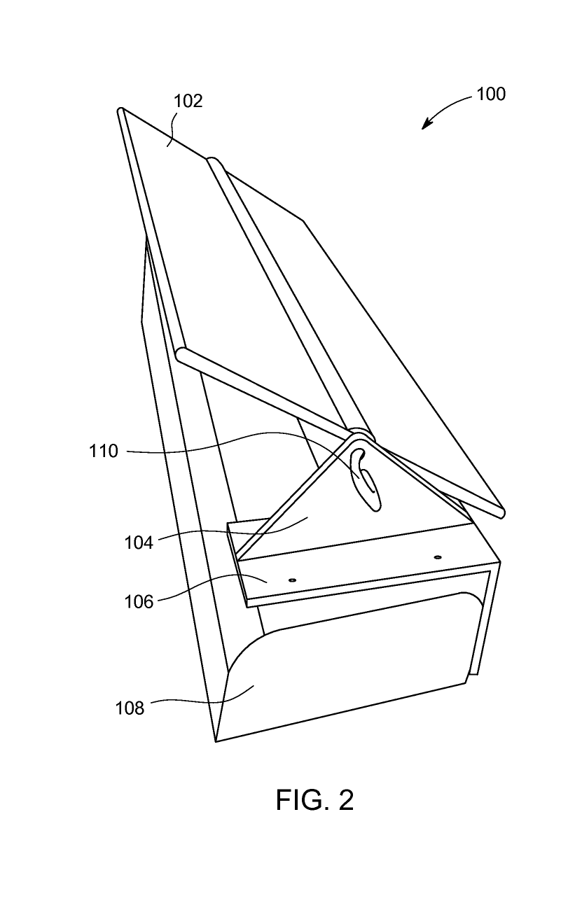

FIG. 2 illustrates an embodiment of the invention

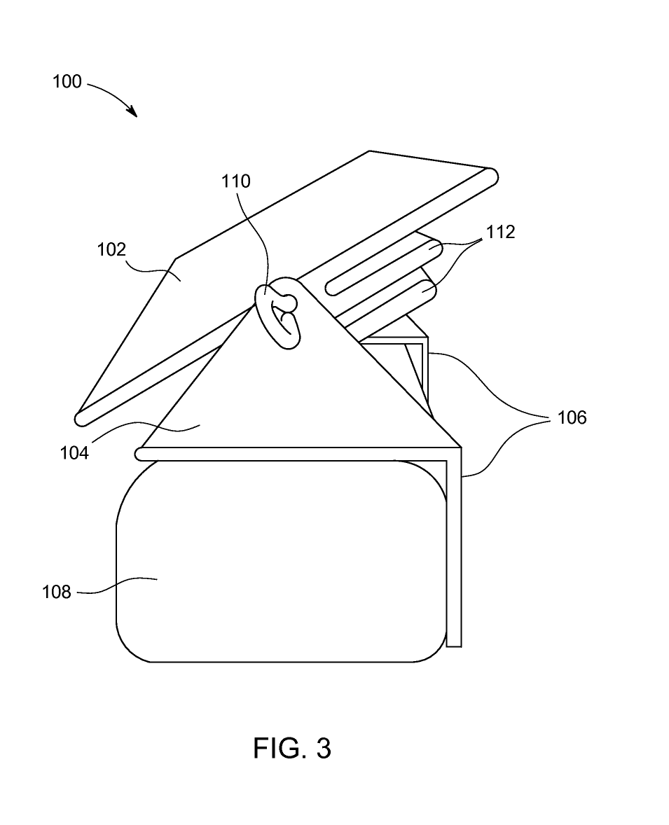

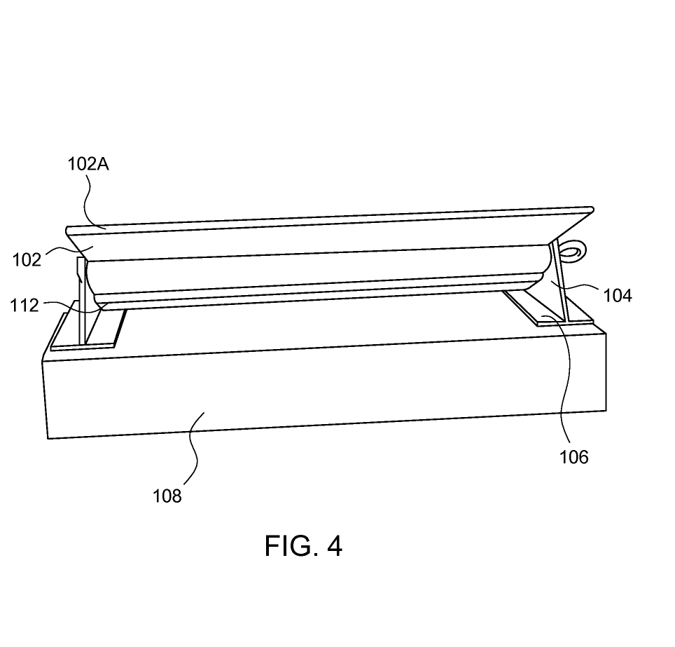

FIG. 3-4 illustrates an embodiment of the invention with weight

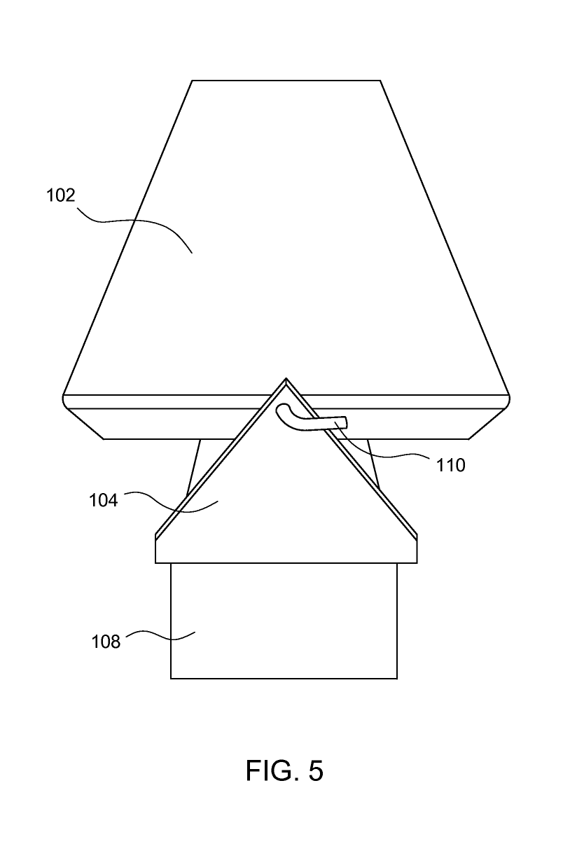

FIG. 5 illustrates an embodiment of the invention without weight

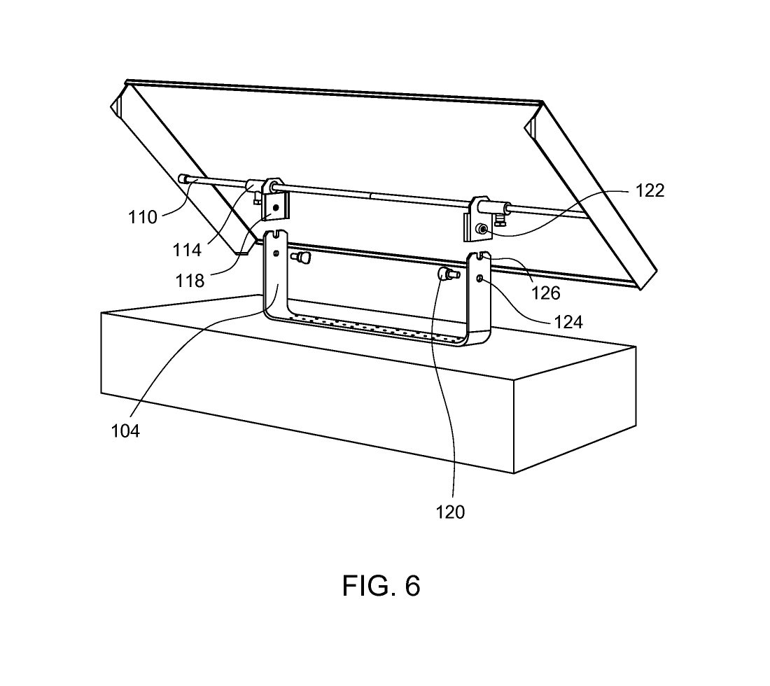

FIG. 6 illustrates an embodiment of the invention with a detachable landing platform

### REFERENCE NUMBERS

100 Bird Repelling Platform
102 Landing platform
102A Upper edge of landing platform
104 Fulcrum
106 base
108 post
110 Rod
112 weight
114 first sleeve
116 sleeve
118 cap
120 screw
122 first hole
124 second hole
126 saddle

FIG. 1 illustrates how a bird instinctively lands on an upper edge 102A of a landing platform. Each bird has a drop distance on a perch, like landing on a branch. If the perch drops lower than the drop distance, the bird will fly off. When a bird looks at the platform, they calculate from past experiences that the solid platform will be a strong, stable structure. The bird has both mentally and physically prepared itself to perch confidently and comfortably on the surface. However, when the weight and kinetic energy of the bird cause the platform to shift, the bird is no longer confident in the stability of the platform, and the bird will instinctively fly off. Even if a bird momentarily achieves balance on the platform, once the platform shifts diagonally and rotates, the bird would slide off, and instinctively fly away. In the case that the bird makes further attempts to land on an unbalanced platform, the cost of expending too much energy would force the bird to seek a more stable landing platform or would force it to hunt for food sooner. In any case, the bird is discouraged from remaining on or returning to the landing platform.

FIG. 2 illustrates an embodiment of the bird repelling platform 100. A landing platform 102 is disposed on a fulcrum 104, and is rotatably secured to the fulcrum 104 with a rod 110 inserted through the fulcrum 104 and through the landing platform 102. The rod 102 is secured in place by a fastener (not shown) at the other end of the fulcrum 104. The fulcrum 104 may consist of two or more separate pieces. The fulcrum 104 is attached to a base 106, and the base is attached to a post 108. The fulcrum 104 and base 106 may constitute one piece or two separate pieces attached together. The base 106 is secured to a post 108. The base can be secured to the post by fasteners or screws (not shown).

FIG. 3 shows extra weight 112 on one side of the landing platform. The weight causes the landing platform 102 to tilt toward the side where the weight 112 is attached, however, FIG. 3 is shown with the landing platform 102 tilted toward the opposite side only for the purpose of revealing the location of the weight

FIG. 4 shows the bird repelling platform 100 with the landing platform 102 tilted toward the side with the weight 112. In FIG. 4, there is now an upper edge of the landing platform 102A that serves as a perch for a bird to land. The weight should be customizable for the type of bird(s) (“target bird”) expected to land on the upper edge of the landing platform 102A. In particular, the weight 112 should be sufficient to tilt the landing platform 102 to one side, but lighter than the target bird(s). FIG. 4 also makes clear that there are two opposing fulcrums 104.

FIG. 5 shows an embodiment of the bird repelling platform without extra weight. In this embodiment, the landing platform 102 may not tilt to one side without the weight of a bird landing on one side. While in FIGS. 2 and 3 the base is attached to two sides of the post, the base of FIG. 5 is attached to only the top side of the post. Moreover, the fulcrum and the base may form one continuous piece rather than two separate pieces. When a bird lands on the horizontally disposed landing platform 102, the landing platform would tilt to one side due to the weight of the bird, causing the bird to lose balance and fly away. Even if the bird lands on the center of the landing platform 102, the bird must expend a lot of energy to remain balanced on the landing platform 102, thereby discouraging the bird from remaining long. Should the bird move slightly, the landing platform 102 would tilt causing the bird to either side and slide off and fly away, or expend more energy to maintain balance, thereby discouraging the bird from remaining.

The landing platform 102 can be removable to make it easier for maintenance and cleaning. While this can be achieved by removing the rod, FIG. 6 shows another embodiment in which caps 118 are rotatably attached to the rod 110 by way of a sleeve 114 around the rod 110. The cap 118 is configured to embrace the fulcrum. The fulcrum 104 has a hole 124 and the cap 118 has a corresponding hole 122, through which a screw 120 is inserted to secure the cap onto the fulcrum 104. A saddle 126 is disposed at the top of the fulcrum to embrace the rod. FIG. 6 shows the fulcrum as one piece, and shows the fulcrum and base as one piece. The fulcrum or fulcrum/base is secured to the post.

It should be understood that the bird repelling platform may comprise a plurality of platforms and can take the form of a pinwheel, wherein the center of the plurality of the landing platforms are rotatably secured to a fulcrum that is attached to a base configured to attach to a post. A bird landing on any of the landing platforms would cause the pinwheel to turn so that the bird loses balance and flies away.

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A bird repelling platform comprising a landing platform, a fulcrum, a weight, a rod, and a base, wherein the landing platform is rotatably secured to the fulcrum with a rod inserted through an opening at an apex of the fulcrum and through a hole in a longitudinal axis of the landing platform, the rod fastened in place with a fastener, the weight attached to a lower side of the landing platform, and the fulcrum secured to a base configured to attach to a post.

2. The bird repelling platform of claim 1, wherein the weight attached to a lower side of the landing platform is of sufficient weight to anchor the landing platform to one side of the fulcrum, but insufficient to offset the weight of a target bird expected to land on an upper side of the landing platform.

3. The bird repelling platform of claim 1, wherein the landing platform is detachable from the fulcrum, when the fastener is unfastened and the rod removed.

4. A bird repelling platform comprising a landing platform disposed on a fulcrum, the landing platform rotatably secured to the fulcrum, the fulcrum secured to a base configured to attach to a post.

5. The bird repelling platform of claim 4, wherein the landing platform is rotatably secured to the fulcrum with a rod.

6. The bird repelling platform of claim 5, wherein the rod is secured in place by a fastener.

7. The bird repelling platform of claim 4, wherein the landing platform is disposed on the fulcrum at a center of the landing platform.

8. The bird repelling platform of claim 4, wherein a weight is disposed to one side of the landing platform, the weight being less than the weight of a target bird expected to land on the landing platform.

8. The bird repelling platform of claim 4, wherein a cap is rotatably attached to the rod, and the cap is configured to detachably attach to the fulcrum,

9. The bird repelling platform of claim 8, wherein the cap is rotatably attached to the rod with a sleeve disposed around the rod.

10. The bird repelling platform of claim 8, wherein the cap is configured to detachably attach to the fulcrum by way of a screw that screws into a hole in the fulcrum and into a corresponding hole of the cap.

11. The bird repelling platform of claim 10, wherein the fulcrum further comprises a saddle at the top of the fulcrum with an area sufficient to embrace the rod.
